(19) United States
(12) Patent Application Publication
(10) Pub. No.: US 2016/0066543 A1
(43) Pub. Date: Mar. 10, 2016

(54) PET COLLAR SLEEVE COVER AND COMBINATION

(71) Applicant: Eileen Couillard, Salem, WI (US)

(72) Inventor: Eileen Couillard, Salem, WI (US)

(21) Appl. No.: 14/616,933

(22) Filed: Feb. 9, 2015

Related U.S. Application Data
(60) Provisional application No. 62/048,326, filed on Sep. 10, 2014.

(51) Int. Cl. A01K 27/00

(52) U.S. Cl. CPC A01K 27/001

(57) ABSTRACT

A sleeve cover is provided for a conventional choke collar. As configured in accordance with the present invention, the sleeve cover does not allow the collar to be drawn too tightly around a dog's neck. The sleeve cover preferably has attachment means disposed at each end of the sleeve cover. The sleeve cover is also provided in combination with a collar of conventional manufacture.

This Application claims the benefit of U.S. Provisional Application No. 62/048,326, filed Sep. 10, 2014.

### FIELD OF THE INVENTION

The present invention relates generally to the field of pets and devices that are used with pets. More particularly, it relates to a sleeve cover that can be placed over a conventional dog collar, and a metal choke chain collar in particular, which reduces the likelihood and risk of injury to a dog's neck during use of the collar. It also relates to the combination of such a sleeve cover with the conventional dog collar.

### BACKGROUND OF THE INVENTION

Many types of collars have been used with dogs to restrain them, control them and train them. While collars can be used advantageously to these ends, one collar in particular is well known to have the potential to cause damage to a dog's neck. That collar is the metal choke chain collar, or simply, a choke collar. When a dog pulls forward and the owner yanks back, a choke collar will tighten suddenly around the dog's neck. The intended goal when using the choke collar is to correct the dog's behavior. In the hands of a skilled trainer or owner, the choke collar can be a safe and effective handling tool. However, and even in the hands of a skilled trainer or owner, this type of metal restraint can cause relatively minor injuries such as bruising and abrasion around the neck and hair loss. However, increased force can cause more serious injuries, such as crushed tracheas, damaged larynxes and even fractured vertebrae.

Accordingly, there is a need to provide a trainer or owner with the ability to use a choke collar with her or his dog while also devising a way to reduce the likelihood of injury to the dog's neck. Such a device would require that the device be easily used with the choke collar and require that the potential hazards posed by the choke collar be reduced or eliminated.

### SUMMARY OF THE INVENTION

Accordingly, it is an object of the present invention to provide a sleeve cover for a conventional choke collar. As configured in accordance with the present invention, the sleeve cover does not allow the collar to be drawn too tightly around the dog's neck. The sleeve cover preferably has attachment means disposed at each end of the sleeve cover.

The foregoing and other advantages of the device of the present invention will be further apparent from the detailed description that follows.

### BRIEF DESCRIPTION OF THE DRAWINGS

FIG. 1 is an illustration of a choke chain collar of the type that is used with the device of the present invention, the collar shown laying straight.

FIG. 2 is the choke chain collar shown in FIG. 1 and illustrating the sleeve cover of the present invention in phantom view.

FIG. 3 is an illustration of the choke chain collar shown in FIGS. 1 and 2, showing the collar as it would be used when applied to a dog's neck without the sleeve cover of the present invention.

FIG. 4 is an illustration of the sleeve cover of the present invention.

FIG. 5 is an enlarged view of the sleeve cover ends and showing their relationship to a choke chain collar that is used in conjunction with the sleeve cover.

### DETAILED DESCRIPTION

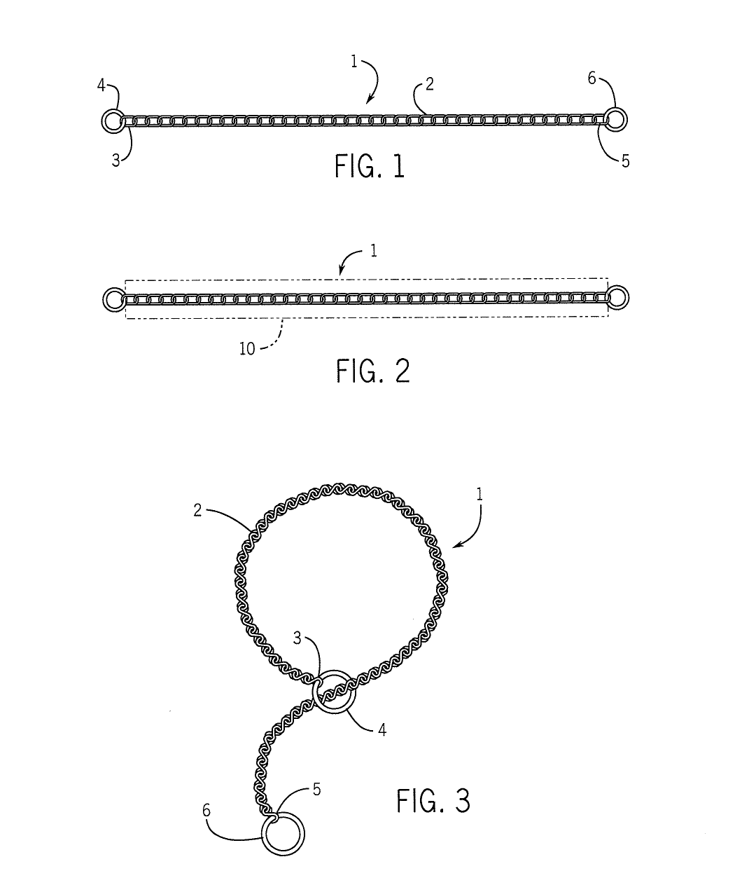

Referring now to the drawings in detail, wherein like numbered elements refer to like elements throughout, FIG. 1 shows a conventional choke chain or collar, generally identified 1. The choke chain or collar 1 comprises a length of chain 2 with rings 4, 6 disposed at each end 3, 5 of the chain 2 such that a collar 1 can be formed into a loop of the chain 2 that slips over the dog's head and rests around the top of the dog's neck. See FIG. 3. When a leash is attached to one ring, called the “dead ring” 4, the collar 1 does not constrict the dog's neck. When a leash is attached to the other ring, called the “live ring” 6, the chain 2 is allowed to be pulled through the dead ring 4 thereby making the collar 1 tighter when pulled and looser when tension is released. Training with this type of collar 1 and a leash (not shown) involves a quick jerk with an immediate release. This is intended to “correct” a dog's unwanted behavior. This is accomplished by pulling on the collar 1 which then presses a portion of the chain 2 on the dog's neck (also not shown). However, pulling on the collar 1 too hard or pulling the collar 1 for an extended period of time can create serious adverse effects for the dog.

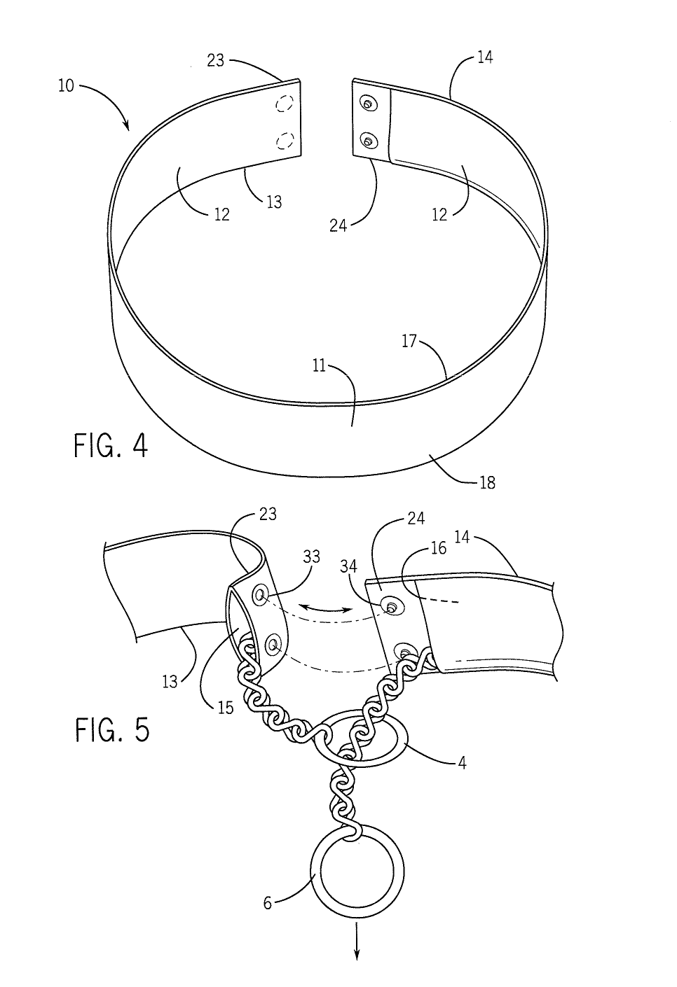

In the device of the present invention, a cover, generally identified 10 is fabricated as a sleeve, the sleeve cover having a front face 11, a rear face 12, a first end 13, a second end 14, a first end opening 15 and a second end opening 16. See FIGS. 4 and 5. The faces 11, 12 are attached along their respective longitudinal sides or edges 17, 18, which sides or edges 17, 18 are common to both of the faces 11, 12, by stitching or folding and stitching. It is to be understood that it would also be within the scope of the present invention to present the sleeve cover 10 as a zippered wrap-around or as a Velcro® hook and loop type wrap-around, either of which could be secured to form a sleeve thereby.

The sleeve cover 10 further comprises end portions 23, 24, each end portion being disposed at or near the openings 14, 15 of the sleeve cover 10. The end portions 23, 24 are integrally formed as part of the sleeve cover 10, but could be separate structures that are fastened thereto. As shown in FIG. 5, the end portion 23 at the first end opening 15 is disposed at such end opening 15 whereas the end portion 24 at the second end opening 16 extends slightly beyond the second end opening 16. This places the end openings 15, 16 immediately adjacent one another. Fixed within each end portion 23, 24 is a snap fastener 33, 34, the snap fasteners 33, 34 being complementary such that one forms a male fastener portion and one forms a female fastener portion. It is also within the scope of the present invention to use other fastening means such as Velcro® loop and hook fasteners, zippers, and the like.

In application, one end of the chain 3, 5 is fed through the sleeve cover 10 such that the end rings 4, 6 are exposed. A portion of the chain 2 and the sleeve cover 10 covering it must pass through one of the rings 4, 6, thereby forming a loop—much in the same way that the loop as shown in FIG. 3 would be created. Once this is completed, the rings 4, 6 engage in a fastening fashion as shown in FIG. 5. In that position, the combination of the collar 1 and the sleeve cover 10 can be passed over the head of the dog and the attachment end of a leash can be secured to the live ring 6. The fasteners 33, 34 disposed at the ends of the sleeve cover 10 would be secured which would then serve to limit the amount of loop closure that can be achieved by the collar 1 while also covering the collar 1 for the comfort and protection of the dog.

Lastly, it is also to be understood that the sleeve cover 10 can be made of any organic or man-made fabric material that is both durable and safe for use with the dog. It is also to be understood that the sleeve cover 10 can be used with any type of conventional collar to achieve the same protective result.

The details of the invention having been disclosed in accordance with the foregoing, I claim:

1. The pet collar sleeve cover of claim 2 wherein the front and rear faces of the sleeve comprise common longitudinal sides or edges and A pet collar sleeve cover for use with a conventional choke chain or collar, the cover comprising:
a sleeve;
a first end opening defined within the sleeve;
a second end opening defined within the sleeve; and
means for removably fastening the first and second end openings of the sleeve to one another.

2. The pet collar sleeve cover of claim 1 wherein the sleeve comprises a front face and a rear face.

3. The pet collar sleeve cover of claim 2 wherein the front and rear faces comprise common longitudinal sides or edges that are attached.

4. The pet collar sleeve cover of claim 3 wherein the longitudinal sides or edges are attached by at least one from a group consisting of stitching, folding and stitching, zippers, and hook and loop fasteners.

5. The pet collar sleeve cover of claim 1 wherein each of the first and second end openings comprise a respective end portion.

6. The pet collar sleeve cover of claim 5 wherein the fastening means comprises complementary fasteners attached to each end portion.

7. The pet collar sleeve cover of claim 6 wherein the fasteners are provided from a group consisting of snap fasteners, hook and loop fasteners and zippers.

8. The pet collar sleeve cover of claim 1 wherein the sleeve is made from an organic material.

9. The pet collar sleeve cover of claim 1 wherein the sleeve is made from a man-made fabric material.

10. A pet collar sleeve cover combination comprising:
a collar;
a sleeve for retaining the collar within the sleeve;
a first end opening defined within the sleeve;
a second end opening defined within the sleeve; and
means for removably fastening the first and second end openings of the sleeve to one another.

11. The pet collar sleeve cover combination of claim 10 wherein the sleeve comprises a front face and a rear face.

12. The pet collar sleeve cover combination of claim 11 wherein the front and rear faces comprise common longitudinal sides or edges that are attached.

13. The pet collar sleeve cover combination of claim 12 wherein the longitudinal sides or edges are attached by at least one from a group consisting of stitching, folding and stitching, zippers, and hook and loop fasteners.

14. The pet collar sleeve cover combination of claim 10 wherein each of the first and second end openings comprise a respective end portion.

15. The pet collar sleeve cover combination of claim 14 wherein the fastening means comprises complementary fasteners attached to each end portion.

16. The pet collar sleeve cover combination of claim 15 wherein the fasteners are provided from a group consisting of snap fasteners, hook and loop fasteners and zippers.

17. The pet collar sleeve cover combination of claim 10 wherein the sleeve is made from an organic material.

18. The pet collar sleeve cover combination of claim 10 wherein the sleeve is made from a man-made fabric material.

19. The pet collar sleeve cover combination of claim 10 wherein the collar is a conventional choke chain.
